(19) United States
(12) Patent Application Publication
(10) Pub. No.: US 2026/0270802 A1
(43) Pub. Date: Sep. 10, 2026

(54) CELLULAR NETWORK OFFLOAD USING WI-FI PASSPOINT

(71) Applicant: T-Mobile USA, Inc., Bellevue, WA (US)

(72) Inventor: Roopesh Kumar Polaganga, Bothell, WA (US)

(21) Appl. No.: 19/073,028

(22) Filed: Mar. 7, 2025

(51) Int. Cl. H04W 36/00; H04L 43/0894; H04W 64/00

(52) U.S. Cl. CPC H04W 36/0022; H04L 43/0894; H04W 64/00

(57) ABSTRACT

The system determines an amount of available bandwidth on a cellular network provided by a base station of a telecommunication network. The system determines that a wireless device is connected to the cellular network. The system measures an amount of bandwidth usage of the wireless device. The system determines that the amount of bandwidth usage of the wireless device exceeds a threshold value. The system calculates a location of the wireless device relative to a coverage area of a Wi-Fi network associated with the telecommunication network. The location of the wireless device is determined using global positioning data or by triangulation through radio waves emitted from the base station. The system provisions, using a Wi-Fi Passpoint protocol, access to the Wi-Fi network by the wireless device. The system causes the wireless device to disconnect from the cellular network and connect to the Wi-Fi Network.

### BACKGROUND

Cellular networks provide wireless connectivity to mobile devices over wide geographic areas. These networks consist of base stations that communicate with user equipment such as smartphones and tablets. As mobile data usage increases, network operators face challenges in managing capacity and providing consistent service, especially in densely populated areas.

Wi-Fi networks offer local wireless connectivity using unlicensed spectrum. Wi-Fi access points are commonly deployed in homes, businesses, and public spaces to provide internet access to nearby devices. Recent Wi-Fi standards aim to improve seamless connectivity and security for users moving between different access points and networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an embodiment of the system.

FIG. 4 is a flowchart that illustrates an embodiment of the system.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to offloading cellular network traffic to Wi-Fi networks using Wi-Fi Passpoint technology, particularly in areas where a network operator has deployed wired internet solutions. With the increasing demand for mobile data, network operators face significant challenges in managing capacity, especially in densely populated areas. When users are connected to Wi-Fi networks, which often have wired backhauls, cellular networks are unnecessarily congested. The strain on the cellular network can lead to reduced performance, slower speeds, and degraded user experience due to overburdened base stations. Therefore, a need exists to free up cellular resources for users who genuinely need them. The disclosed technology reduces congestion on cellular networks by transitioning mobile devices to Wi-Fi networks without requiring user intervention. The system leverages knowledge of wired HSI locations and Wi-Fi Passpoint capabilities to optimize network resources and improve user experience.

The disclosed system pre-provisions mobile devices with Wi-Fi Passpoint configurations and maintains a database of wired Wi-Fi network locations to offload cellular network traffic to Wi-Fi networks. The system can include a database for maintaining information about wired and wireless Wi-Fi backhaul locations. The base station can determine wireless device locations through techniques such as global positioning system (GPS) or network-based triangulation. The system monitors cellular network usage for mobile devices connected to the base station. When a mobile device's resource or bandwidth consumption exceeds a predefined threshold and the wireless device is within range of a wired Wi-Fi network, the system instructs the wireless device to connect to the Wi-Fi network using Wi-Fi Passpoint protocols. The system dynamically adjusts offloading thresholds based on network conditions and location-specific factors. For example, when the system detects that a wireless device is consuming significant network resources and is near a Wi-Fi network supported by a wired Wi-Fi backhaul, the system can trigger the offloading process using Access Network Discovery and Selection Function (ANDSF) protocols to direct the wireless device to connect to the Wi-Fi network.

The wireless device can include software enabling the reception and processing of ANDSF messages from the cellular network. When instructed by the cellular network, the wireless device can automatically enable its Wi-Fi radio, scan for and connect to a specified Wi-Fi network using Passpoint authentication, and route data traffic through the Wi-Fi connection instead of the cellular network. The system can also monitor the quality of the Wi-Fi connection and revert to the cellular network if the Wi-Fi signal degrades or becomes unavailable. The transition to Wi-Fi occurs automatically without user input, enabling the offloading of data traffic from the cellular network to the wired Wi-Fi network. Therefore, the disclosed system enables the automatic connection of wireless devices to Wi-Fi networks associated with wired home internet services, reducing congestion on cellular networks. The offloading process can help reduce congestion on cellular networks by leveraging available Wi-Fi infrastructure. By dynamically managing these transitions, the system can improve overall network performance and user experience.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

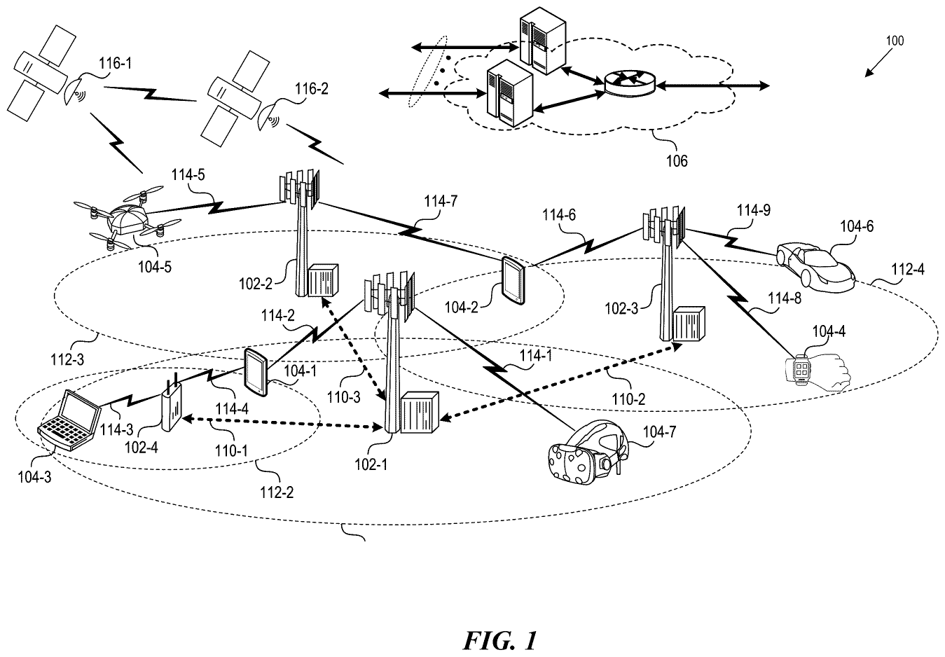

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

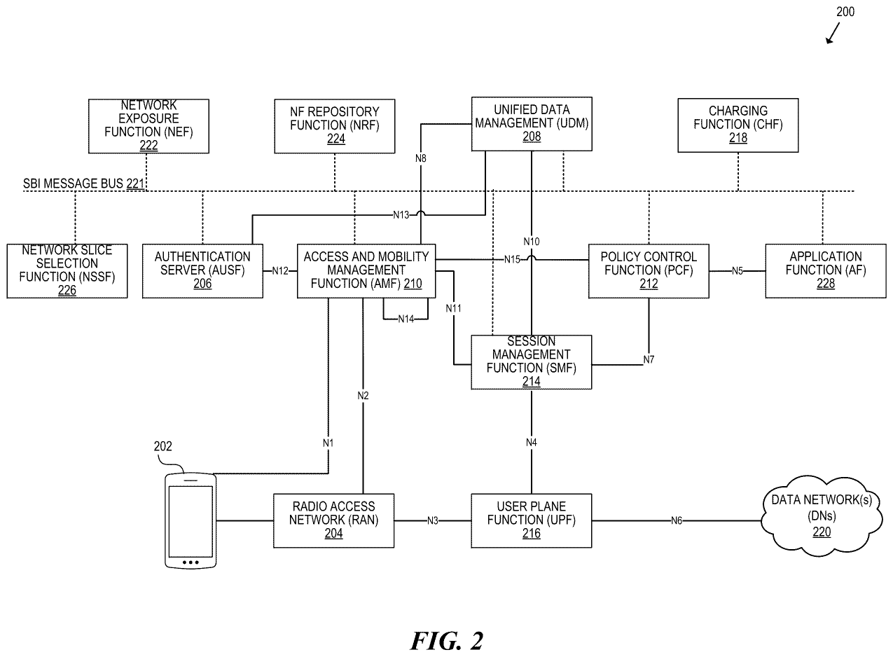

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Cellular Offloading

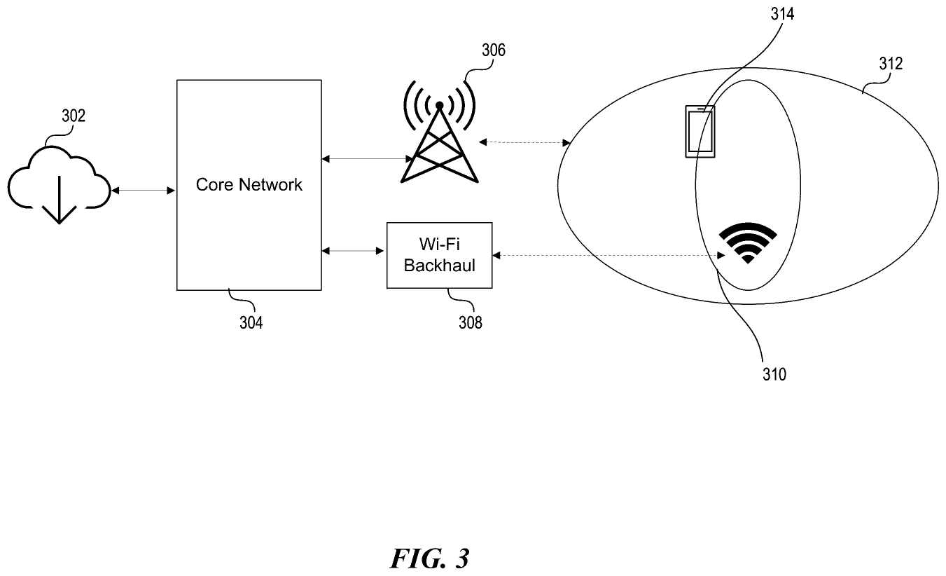

FIG. 3 is a block diagram that illustrates an embodiment of the system for offloading wireless device 314 from a cellular network 312 to a Wi-Fi network 310 to increase the user experience of the wireless device 314 when accessing the internet 302. The system includes the core network 304, a base station 306, and a wired backhaul 308. The base station 306 provides a cellular network 312 to a geographic area. The base station 306 enables the wireless device 314 to access the internet 302 through the core network 304 when the wireless device 314 is connected to the cellular network 312. The backhaul 308 is the connection between the core network 304 and a Wi-Fi access node that provides the Wi-Fi network 310. The backhaul 308 enables the wireless device 314 to access the internet 302 through the core network 304 when the wireless device 314 is connected to the Wi-Fi network 310. The Wi-Fi network 310 is located within a geographic area serviced by the cellular network 312. In some embodiments, the backhaul 308 is a wired backhaul and can be a fiber backhaul using fiber optic cables to connect the wireless device 314 to the core network 304.

The system can monitor the network demand on the base station 306 to determine when to offload the wireless device 314 from the cellular network 312 to a Wi-Fi network 310 in range of the wireless device 314. The system can offload the wireless device 314 from the cellular network 312 to a Wi-Fi network 310 to decrease the demand on the cellular network 312, increasing the user experience of both offloaded and non-offloaded wireless devices.

The system monitors and analyzes the bandwidth utilization of cellular network 312 to determine if the wireless device 314 should be offloaded to the Wi-Fi network 310. In some embodiments, the system also monitors and analyzes the bandwidth usage of each available Wi-Fi network 310 within the geographic area of the cellular network 312. The system can define a threshold for bandwidth or resource utilization that triggers offloading. The threshold value can be based on various factors, such as the number of physical resource blocks utilized, data throughput, a time of day, the amount of available bandwidth on the cellular network, the amount of bandwidth usage of the wireless device, a type of network usage by the wireless device, the location of the wireless device relative to a location of the Wi-Fi network, a total number of wireless devices connected to the cellular network, or other metrics indicating network load. For example, the threshold value can be set as a percentage of total bandwidth on the cellular network 312 or Wi-Fi network 310 and/or a total number of wireless devices 314 connected to the cellular network 312. For example, the system can continuously monitor (e.g., every 1, 2, 5, or 10 minutes) the cellular network 312, and when the bandwidth utilization of the wireless device 314 exceeds the defined threshold value, the system can initiate the offloading process.

The thresholds can be dynamically adjusted based on network conditions and location-specific factors. For example, in areas with high cellular network congestion, the threshold can be lowered to trigger offloading more readily. Conversely, the threshold can be raised in areas with ample cellular capacity to enable more traffic on the cellular network 312. Location-specific factors that can influence threshold adjustments include the density of Wi-Fi networks 310 in the area, the capacity of the backhaul 308 supporting the Wi-Fi networks 310, and/or historical usage patterns. In some embodiments, the system can employ machine learning models to dynamically adjust the threshold values based on current network conditions (e.g., within the last 1, 5, 10, or 15 minutes) and historical data. The machine learning model can be trained with historical data and/or curated datasets. Additionally, the system can also implement different thresholds for various types of traffic or user equipment. For example, delay-sensitive applications can have higher thresholds to prioritize their traffic on the cellular network 312, while less time-critical applications can have lower thresholds to encourage offloading.

When the threshold is reached, the system instructs the wireless device 314 to connect to Wi-Fi network 310. The wireless device 314 can connect to the Wi-Fi network 310 without needing to input a password, even if one is required otherwise. To determine if the wireless device 314 is in range of the Wi-Fi network 310, the system can use cellular triangulation to determine the wireless device's 314 location.

The system can include a database for maintaining data and information about the locations of each available Wi-Fi network 310 in the geographic area of the cellular network 312. In some embodiments, the same network service provider that operates the cellular network 312 can provide the backhaul 308 that supports the Wi-Fi network 310. Therefore, the system has access to the location information of each available Wi-Fi network 310. Additionally, the database can include background information about the location of the Wi-Fi network 310, such as whether the location is a personal residency or a business, including the type of business.

After the offloading conditions are met, the system can cause the wireless device 314 to disconnect from the cellular network 312 and then to connect to the Wi-Fi network 310. When Wi-Fi settings are enabled on the wireless device 314, and the wireless device 314 has previously connected to the Wi-Fi network 310, the wireless device 314 can automatically connect to the Wi-Fi network 310 without re-verification and authorization by the system. When Wi-Fi settings are not enabled and/or the wireless device 314 has not previously connected to the Wi-Fi network 310, the system transmits Wi-Fi access rules via the ANDSF to the wireless device 314. The ANDSF causes the wireless device 314 to begin searching for nearby Wi-Fi networks and can include information such as the telecommunication network defined rules and parameters that limit which Wi-Fi networks 310 the wireless device 314 searches for. The Wi-Fi access rules can specify which Wi-Fi networks 310 are available for offloading, authentication methods, and other connection parameters. Upon receiving the Wi-Fi access rules, the wireless device is caused to automatically initiate a connection to the Wi-Fi network 310 using Wi-Fi Passpoint protocols. Wi-Fi Passpoint, also known as Hotspot 2.0, is a technology that enables wireless devices to automatically connect to Wi-Fi networks. Wi-Fi Passpoint eliminates the need to search for and authenticate to a network each time a device connects to a Wi-Fi network while also providing enterprise-level security to protect the wireless device 314 and the Wi-Fi network 310.

The Wi-Fi Passpoint can involve provisioning the wireless device 314 with enterprise-based Wi-Fi Passpoint settings specific to the telecommunication network. The Wi-Fi network 310 is also configured to support Wi-Fi Passpoint protocols. The Wi-Fi network 310 can broadcast information about the Wi-Fi network capabilities using Access Network Query Protocol (ANQP) to enable the wireless device 314 to discover and access the Wi-Fi network 310 without user intervention. ANQP is a communication protocol used in Wi-Fi networks, specifically for allowing devices to discover and gather information about available hotspots, including details like the network operator, authentication methods, and/or available IP address types. The wireless device 314 can be configured with protocols to look for certified networks and use ANQP to obtain Wi-Fi network information. When the wireless device 314 comes within range of a compatible Wi-Fi network 310, the system can automatically initiate the connection process.

The connection process can involve mutual authentication between the wireless device 314 and the Wi-Fi network 310. The authentication can use Extensible Authentication Protocol (EAP) methods to verify the identity of both the wireless device 314 and the Wi-Fi network 310. To ensure the security of data transmitted during the offloading process, the Wi-Fi network 310 can utilize Wi-Fi protected access (WPA) 2 and/or 3 encryption. WPA is a security protocol that protects wireless networks from unauthorized access and uses encryption and authentication to ensure that only authorized users can connect to the Wi-Fi network. Therefore, WPA encryption helps protect the confidentiality and integrity of user data as the user data travels between the wireless device 314 and the Wi-Fi network 310.

In some embodiments, the system can be coupled to a database of authorized Wi-Fi networks and the associated security parameters. In some other embodiments, the system maintains a centralized network planning tool. The centralized network planning tool maintains and manages information relating to the location and amount of bandwidth of each base station 306 and Wi-Fi network 310 in the telecommunication network and/or the security parameters for each. The information in the database and/or centralized network planning tool can be used to validate connection requests and ensure that the wireless device 314 only connects to trusted Wi-Fi networks.

In some embodiments, the wireless device 314 can locally store multiple sets of Wi-Fi Passpoint credentials to enable the wireless device 314 to connect to different Wi-Fi networks, depending on the wireless device's 314 location and network availability. The Wi-Fi Passpoint configuration can also include provisions for roaming between different Wi-Fi networks. As the wireless device 314 moves between coverage areas of different Wi-Fi networks, the wireless device 314 can automatically transition to the new Wi-Fi network without requiring user input or reauthentication.

After offloading the wireless device 314 to the Wi-Fi network 310, the system monitors the status of both the cellular network 312 and the Wi-Fi network 310, ensuring that the wireless device 314 does not experience user experience issues. The wireless device 314 can disconnect from the Wi-Fi network 310 and reconnect to the cellular network 312 based on a change in the location of the wireless device 314 to a location outside the coverage area of the Wi-Fi network 310, a degradation of the signal strength of the Wi-Fi network 310 above a threshold value, the total bandwidth usage of the Wi-Fi network 310 being above a threshold value, the bandwidth usage of the wireless device 314 being below a threshold value, or a decrease in total bandwidth usage of the cellular network above a threshold value. For example, when the Wi-Fi signal quality degrades or the user moves out of Wi-Fi range, the system can transition the wireless device 314 back to the cellular network 312 or to a different Wi-Fi network.

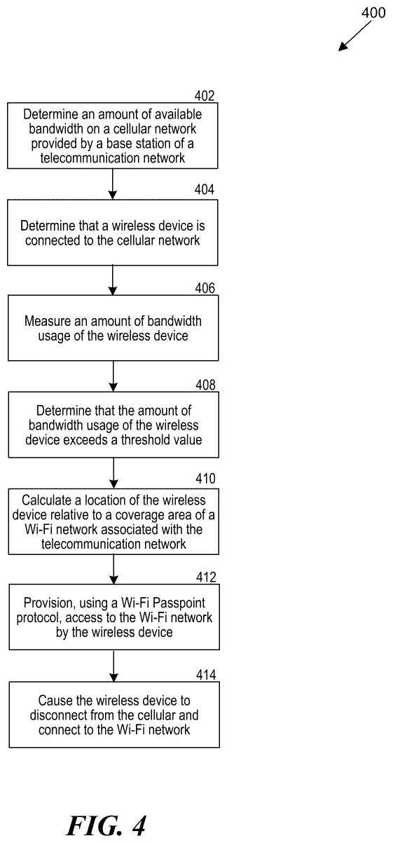

FIG. 4 is a flowchart of a process 400 performed by an embodiment of the system. In one example, the system includes at least one hardware processor and at least one non-transitory memory storing instructions, which, when executed by the at least one hardware processor, cause the system to perform the process 400.

At 402, the system determines an amount of available bandwidth on a cellular network provided by a base station of a telecommunication network. At 404, the system determines that a wireless device is connected to the cellular network. At 406, the system measures an amount of bandwidth usage of the wireless device.

At 408, the system determines that the amount of bandwidth usage of the wireless device exceeds a threshold value. In some embodiments, the system calculates the threshold value based on at least one of the following: a time of day, the amount of available bandwidth on the cellular network, the amount of bandwidth usage of the wireless device, a type of network usage by the wireless device, the location of the wireless device relative to a location of the Wi-Fi network, or a total number of wireless devices connected to the cellular network.

At 410, the system calculates a location of the wireless device relative to a coverage area of a Wi-Fi network associated with the telecommunication network. The location of the wireless device is determined using global positioning data or by triangulation through radio waves emitted from the base station. The Wi-Fi network is provided using a wired internet backhaul. In some embodiments, the system monitors a database of Wi-Fi networks associated with the telecommunication network, where the database includes location data and coverage area data of the Wi-Fi networks associated with the telecommunication network.

At 412, the system provisions, using a Wi-Fi Passpoint protocol, access to the Wi-Fi network by the wireless device. In some embodiments, the system configures the Wi-Fi network for use with the Wi-Fi Passpoint protocol and transmits a Wi-Fi access rule, via Access Network Discovery and Selection Function, to the wireless device. In some other embodiments, the system causes the wireless device to locally save the Wi-Fi Passpoint protocols. Locally saving the Wi-Fi Passpoint protocols enables the wireless device to automatically connect to the Wi-Fi network. The system monitors the Wi-Fi network for a disconnection of the wireless device from the Wi-Fi network. The system monitors the Wi-Fi network for a reconnection of the wireless device to the Wi-Fi network.

At 414, the system causes the wireless device to disconnect from the cellular network and connect to the Wi-Fi Network. In some embodiments, the Wi-Fi network is a first Wi-Fi network, and the system calculates an update to the location of the wireless device. The system detects that the wireless device has disconnected from the first Wi-Fi network and reconnected to the cellular network. The system determines that the wireless device is in range of a second Wi-Fi network or out of range of the first Wi-Fi network. The system determines, based on the database, whether the second Wi-Fi network is provided through a wired internet backhaul or through the cellular network. The system causes the wireless device to stay connected to the cellular network when the second Wi-Fi network is provided through the cellular network. In some other embodiments, the system monitors a signal strength of the Wi-Fi network, a bandwidth usage of the wireless device on the Wi-Fi network, or a total bandwidth usage of the Wi-Fi network. The system causes the wireless device to disconnect from the Wi-Fi network and reconnect to the cellular network based on at least one of the following: a change in location of the wireless device to a location outside the coverage area of the Wi-Fi network, a degradation of the signal strength of the Wi-Fi network above a threshold value, the total bandwidth usage of the Wi-Fi network being above a threshold value, the bandwidth usage of the wireless device being below a threshold value, or a decrease in total bandwidth usage of the cellular network above a threshold value.

In some embodiments, the system is a wireless device. The system connects the wireless device to a cellular network transmitted by a base station of a telecommunication network. The system calculates an amount of bandwidth used by the wireless device on the cellular network. The system receives a threshold bandwidth usage amount from the telecommunication network. The system receives, over the cellular network, a list of Wi-Fi networks associated with the telecommunication network from the base station. The list of Wi-Fi networks includes location and coverage area data of the Wi-Fi network.

The system calculates a location of the wireless device relative to a coverage area of a Wi-Fi network associated with the telecommunication network. The location of the wireless device can be determined using global positioning system (GPS) coordinates, and the coverage area of the Wi-Fi network can be determined using GPS coordinates.

The system provisions, using a Wi-Fi Passpoint protocol, access to the Wi-Fi network by the wireless device. In some embodiments, the system can receive a Wi-Fi access rule, via Access Network Discovery and Selection Function, from the base station. In some other embodiments, the system can save the Wi-Fi Passpoint protocols locally on the wireless device, where saving the Wi-Fi Passpoint protocols enables the wireless device to automatically reconnect to the Wi-Fi network after disconnecting from the Wi-Fi network.

The system disconnects from the cellular network transmitted by the base station. The system connects to the Wi-Fi Network. In some embodiments, the Wi-Fi network is a first Wi-Fi network, and the system can calculate an update to the location of the wireless device relative to the coverage area of the first Wi-Fi network. The update indicates that the wireless device is out of range of the first Wi-Fi network. The system can determine, based on the list of Wi-Fi networks, that the wireless device is in range of a second Wi-Fi network. The system can connect to the second Wi-Fi network. In some other embodiments, the system can disconnect from the Wi-Fi network based on at least one of the following: a degradation of a signal strength of the Wi-Fi network above a threshold value, the bandwidth usage of the wireless device being below a threshold value, or the base station indicating a decrease in total bandwidth usage of the cellular network is above a threshold value. The system can reconnect to the cellular network.

### Computer System

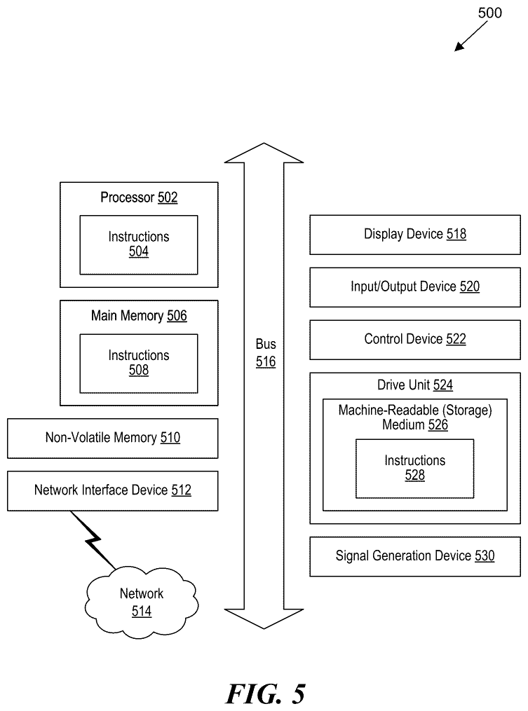

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
determine an amount of available bandwidth on a cellular network provided by a base station of a telecommunication network;
determine that a wireless device is connected to the cellular network;
measure an amount of bandwidth usage of the wireless device;
determine that the amount of bandwidth usage of the wireless device exceeds a threshold value;
calculate a location of the wireless device relative to a coverage area of a Wi-Fi network associated with the telecommunication network,
wherein the location of the wireless device is determined using global positioning data or by triangulation through radio waves emitted from the base station, and
wherein the Wi-Fi network is provided using a wired internet backhaul;
provision, using a Wi-Fi Passpoint protocol, access to the Wi-Fi network by the wireless device; and
cause the wireless device to disconnect from the cellular network and connect to the Wi-Fi Network.

2. The non-transitory, computer-readable storage medium of claim 1, wherein the instructions further cause the system to:
calculate the threshold value based on at least one of the following: a time of day, the amount of available bandwidth on the cellular network, the amount of bandwidth usage of the wireless device, a type of network usage by the wireless device, the location of the wireless device relative to a location of the Wi-Fi network, or a total number of wireless devices connected to the cellular network.

3. The non-transitory, computer-readable storage medium of claim 1, wherein the instructions further cause the system to:
monitor a database of Wi-Fi networks associated with the telecommunication network,
wherein the database includes location data and coverage area data of the Wi-Fi networks associated with the telecommunication network.

4. The non-transitory, computer-readable storage medium of claim 3, wherein the Wi-Fi network is a first Wi-Fi network, and wherein the instructions further cause the system to:
calculate an update to the location of the wireless device;
detect that the wireless device has disconnected from the first Wi-Fi network and reconnected to the cellular network;
determine that the wireless device is in range of a second Wi-Fi network or out of range of the first Wi-Fi network;
determine, based on the database, whether the second Wi-Fi network is provided through a wired internet backhaul or through the cellular network; and
cause the wireless device to stay connected to the cellular network when the second Wi-Fi network is provided through the cellular network.

5. The non-transitory, computer-readable storage medium of claim 1, wherein the instructions further cause the system to:
configure the Wi-Fi network for use with the Wi-Fi Passpoint protocol; and
transmit a Wi-Fi access rule, via Access Network Discovery and Selection Function, to the wireless device.

6. The non-transitory, computer-readable storage medium of claim 1, wherein the instructions further cause the system to:
monitor a signal strength of the Wi-Fi network, a bandwidth usage of the wireless device on the Wi-Fi network, or a total bandwidth usage of the Wi-Fi network; and
cause the wireless device to disconnect from the Wi-Fi network and reconnect to the cellular network based on at least one of the following: a change in location of the wireless device to a location outside the coverage area of the Wi-Fi network, a degradation of the signal strength of the Wi-Fi network above a threshold value, the total bandwidth usage of the Wi-Fi network being above a threshold value, the bandwidth usage of the wireless device being below a threshold value, or a decrease in total bandwidth usage of the cellular network above a threshold value.

7. The non-transitory, computer-readable storage medium of claim 1, wherein the instructions further cause the system to:
cause the wireless device to locally save the Wi-Fi Passpoint protocols,
wherein locally saving the Wi-Fi Passpoint protocols enables the wireless device to automatically connect to the Wi-Fi network;
monitor the Wi-Fi network for a disconnection of the wireless device from the Wi-Fi network; and
monitor the Wi-Fi network for a reconnection of the wireless device to the Wi-Fi network.

8. A wireless device comprising:
at least one hardware processor; and
at least one non-transitory memory storing instructions, which, when executed by the at least one hardware processor, cause the wireless device to:
connect the wireless device to a cellular network transmitted by a base station of a telecommunication network;
calculate an amount of bandwidth used by the wireless device on the cellular network;
receive a threshold bandwidth usage amount from the telecommunication network;
receive, over the cellular network, a list of Wi-Fi networks associated with the telecommunication network from the base station,
wherein the list of Wi-Fi networks includes location and coverage area data of the Wi-Fi network;
calculate a location of the wireless device relative to a coverage area of a Wi-Fi network associated with the telecommunication network;
provision, using a Wi-Fi Passpoint protocol, access to the Wi-Fi network by the wireless device;
disconnect from the cellular network transmitted by the base station; and
connect to the Wi-Fi Network.

9. The wireless device of claim 8, wherein the threshold bandwidth usage amount is based on at least one of the following: a time of day, the amount of available bandwidth on the base station, the amount of bandwidth usage of the wireless device, a type of network usage by the wireless device, the location of the wireless device relative to the Wi-Fi network, or a total number of wireless devices connected to the cellular network transmitted by the base station.

10. The wireless device of claim 8, wherein the location of the wireless device is determined using global positioning system (GPS) coordinates, and the coverage area of the Wi-Fi network is determined using GPS coordinates.

11. The wireless device of claim 8, wherein the Wi-Fi network is a first Wi-Fi network, and wherein the wireless device is further caused to:
calculate an update to the location of the wireless device relative to the coverage area of the first Wi-Fi network,
wherein the update indicates that the wireless device is out of range of the first Wi-Fi network;
determine, based on the list of Wi-Fi networks, that the wireless device is in range of a second Wi-Fi network; and
connect to the second Wi-Fi network.

12. The wireless device of claim 8, wherein the Wi-Fi network is provided using a wired internet backhaul.

13. The wireless device of claim 8, wherein the wireless device is further caused to:
receive a Wi-Fi access rule, via Access Network Discovery and Selection Function, from the base station.

14. The wireless device of claim 8, wherein the wireless device is further caused to:
disconnect from the Wi-Fi network based on at least one of the following: a degradation of a signal strength of the Wi-Fi network above a threshold value, the bandwidth usage of the wireless device being below a threshold value, or the base station indicating a decrease in total bandwidth usage of the cellular network is above a threshold value; and
reconnect to the cellular network.

15. The wireless device of claim 8, wherein the wireless device is further caused to:
save the Wi-Fi Passpoint protocols locally on the wireless device,
wherein saving the Wi-Fi Passpoint protocols enables the wireless device to automatically reconnect to the Wi-Fi network after disconnecting from the Wi-Fi network.

16. A method comprising:
determining an amount of available bandwidth on a cellular network provided by a base station of a telecommunication network;
determining that a wireless device is connected to the cellular network;
measuring an amount of bandwidth usage of the wireless device;
determining that the amount of bandwidth usage of the wireless device exceeds a threshold value;
calculating a location of the wireless device relative to a coverage area of a Wi-Fi network associated with the telecommunication network,
wherein the location of the wireless device is determined using global positioning data or by triangulation through radio waves emitted from the base station, and
wherein the Wi-Fi network is provided using a wired internet backhaul;
provisioning, using a Wi-Fi Passpoint protocol, access to the Wi-Fi network by the wireless device; and
causing the wireless device to disconnect from the cellular network and connect to the Wi-Fi Network.

17. The method of claim 16, further comprising:
calculating the threshold value based on at least one of the following: a time of day, the amount of available bandwidth on the cellular network, the amount of bandwidth usage of the wireless device, a type of network usage by the wireless device, the location of the wireless device relative to a location of the Wi-Fi network, or a total number of wireless devices connected to the cellular network.

18. The method of claim 16, wherein the Wi-Fi network is a first Wi-Fi network, the method further comprising:
calculating an update to the location of the wireless device;
detecting that the wireless device has disconnected from the first Wi-Fi network or reconnected to the cellular network;
determining that the wireless device is in range of a second Wi-Fi network or out of range of the first Wi-Fi network;
determining whether the second Wi-Fi network is provided through a wired internet backhaul or through the cellular network; and
causing the wireless device to stay connected to the cellular network when the second Wi-Fi network is provided through the cellular network.

19. The method of claim 16, further comprising:
configuring the Wi-Fi network for use with the Wi-Fi Passpoint protocol; and
transmitting a Wi-Fi access rule, via Access Network Discovery and Selection Function, to the wireless device.

20. The method of claim 16, further comprising:
causing the wireless device to locally save the Wi-Fi Passpoint protocols,
wherein locally saving the Wi-Fi Passpoint protocols enables the wireless device to automatically connect to the Wi-Fi network;
monitoring the Wi-Fi network for a disconnection of the wireless device from the Wi-Fi network; and
monitoring the Wi-Fi network for a reconnection of the wireless device to the Wi-Fi network.
